(19) United States
(12) Patent Application Publication
(10) Pub. No.: US 2021/0407008 A1
(43) Pub. Date: Dec. 30, 2021

(54) Method and System for Equitably Allocating Financial Distributions

(71) Applicant: BATTLELINE TECHNOLOGIES, LLC, Delray Beach, FL (US)

(72) Inventors: David Boydell, Sonoma, CA (US); Jeremy Roseberry, Delray Beach, FL (US)

(73) Assignee: FairShares, Inc., Delray Beach, FL (US)

(21) Appl. No.: 17/052,716

(22) PCT Filed: Jul. 5, 2019
(86) PCT No.: PCT/US19/40735

§ 371 Date: Nov. 3, 2020

Related U.S. Application Data
(60) Provisional application No. 62/694,363, filed on Jul. 5, 2018.
(60) Provisional application No. 62/787,563, filed on Jan. 2, 2019.
(60) Provisional application No. 62/854,886, filed on May 30, 2019.

(51) Int. Cl. G06Q 40/06; G06Q 40/04; G06Q 40/02

(52) U.S. Cl. CPC G06Q 40/06; G06Q 40/02; G06Q 40/04

(57) ABSTRACT

A method includes: receiving, by a payment agent, from an issuer of a security, a declaration that the total distribution will be issued by the security issuer; instructing, by the payment agent, to the security issuer, to send to a bank, on behalf of the payment agent, the total distribution for a payment period comprising a plurality of intervals; receiving, by the payment agent, data regarding one or more of a position of the investor in the security at an end of the interval and a length of the interval; computing, by the payment agent, using the data, an individual distribution payable to the investor, the individual distribution equitably allocating a portion of the total distribution to an investor who owns the security at the end of at least one of the intervals; and instructing the bank, by the payment agent, to pay the individual distribution to the investor.

### PRIORITY CLAIM

The present application claims the priority benefit of U.S. provisional patent application No. 62/694,363 filed Jul. 5, 2018 and entitled “Method and System for Equitably Allocating Financial Distributions,” of U.S. provisional patent application No. 62/787,563 filed Jan. 2, 2019 and entitled “Investment Fund for Equitably Allocating Financial Distributions,” and of U.S. provisional patent application No. 62/854,886 filed May 30, 2019 and entitled “System and Method for Removing a Distribution from a Value of a Security,” the disclosures of which are incorporated herein by reference.

### CROSS-REFERENCE TO RELATED APPLICATIONS

This application contains subject matter that is related to the subject matter of the following applications, which are assigned to the same assignee as this application. The below-listed applications are hereby incorporated by reference in their entirety, apart from the limitations mentioned in this paragraph. Any incorporation by reference of documents below is limited such that no subject matter is incorporated that is contrary to the explicit disclosure herein. Any incorporation by reference of documents below is further limited such that no claims included in the documents are incorporated by reference herein. Any incorporation by reference of documents above is yet further limited such that any definitions, disavowals; disclaimers, and claims provided in the documents are not incorporated by reference herein unless expressly included herein:

“INVESTMENT FUND FOR EQUITABLY ALLOCATING A FINANCIAL DISTRIBUTION TO MULTIPLE INVESTORS,” by Boydell and Roseberry, co-filed herewith.

“SYSTEM AND METHOD FOR EQUITABLY ALLOCATING A FINANCIAL DISTRIBUTION TO MULTIPLE INVESTORS USING A PAYMENT AGENT,” by Boydell and Roseberry, co-filed herewith.

“METHOD AND SYSTEM FOR ESTIMATING ACCRUED, EQUITABLY ALLOCATED DISTRIBUTION INCOME FROM A SECURITY,” by Boydell and Roseberry, co-filed herewith.

### SUMMARY

Embodiments of the invention relate in general to a method and system for equitably allocating a financial distribution. Embodiments of the invention relate to a method and system for equitably allocating a financial distribution based on one or more of a time of securities owned, a quantity of securities owned, security ownership data, and the like.

A method for equitably allocating a total distribution by a security to an investor includes: receiving, by a payment agent, from an issuer of a security, a declaration that the total distribution will be issued by the security issuer; instructing, by the payment agent, to the security issuer, to send to a bank the total distribution for a payment period comprising a plurality of intervals; receiving, by the payment agent, data regarding one or more of a position of the investor in the security at an end of the interval and a length of the interval; computing, by the payment agent, using the data, an individual distribution payable to the investor, the individual distribution equitably allocating a portion of the total distribution to an investor who owns the security at an end of at least one of the intervals; and instructing the bank, by the payment agent, to pay the individual distribution to the investor.

A method for equitably allocating a total distribution by a security to an investor comprising: receiving, by a payment agent, from an issuer of a security, a declaration that the total distribution will be issued by the security issuer; instructing, by the payment agent, to the security issuer, to send to a bank the total distribution for a payment period comprising a plurality of intervals; receiving, by the payment agent, data regarding one or more of a position of the investor in the security at an end of the interval and a length of the interval; aggregating, by the payment agent, the data; determining, by the payment agent, that data is missing that the payment agent needs to compute the equitable allocation of the total distribution; requesting, by the payment agent, that missing data needed to compute the equitable allocation be provided to the payment agent; determining, by the payment agent, that the aggregated data needed to compute the equitable allocation has arrived to the payment agent, thereby concluding a data aggregation period; computing, by the payment agent, using the data, an individual distribution payable to the investor, the individual distribution equitably allocating a portion of the total distribution to an investor who owns the security at an end of at least one of the intervals, wherein computing comprises calculating a sum over the payment period of share-intervals for the investor, where a share-interval comprises a product of a length of the interval at the end of which the investor owned the security and shares of the security owned by the investor at the end of the interval, wherein computing further comprises dividing the sum of share-intervals for the investor by a sum of share-intervals for all investors during the payment period, and then multiplying by the total distribution; instructing the bank, by the payment agent, to send the total distribution on behalf of the payment agent to all the investors; and verifying, by the payment agent, that the bank has paid the individual distribution to the investor.

### DESCRIPTION OF THE DRAWINGS

The accompanying drawings provide visual representations which will be used to more fully describe various representative embodiments and can be used by those skilled in the art to better understand the representative embodiments disclosed herein and their inherent advantages. In these drawings, like reference numerals identify corresponding elements.

FIG. 1 is a block diagram of a system for equitably allocating a financial distribution.

FIGS. 2A-2D depict an example of a method for equitably allocating a financial distribution.

FIG. 3 is a flow chart of a method for equitably allocating a financial distribution.

FIG. 4 is a flow chart of a method for equitably allocating a financial distribution.

### DETAILED DESCRIPTION

Embodiments of the invention relate in general to a method and system for equitably allocating a financial distribution.

A security comprises a financial instrument available for acquisition by an investor hoping for a financial return on the investment. For example, a security comprises one or more of a note, a common stock, a preferred stock, a security future, a security-based swap, a bond, a debenture, evidence of indebtedness, a certificate of interest in a profit-sharing agreement, a certificate of participation in a profit-sharing agreement, a collateral-trust certificate, a preorganization certificate, a preorganization subscription, a transferable share, an investment contract, a voting-trust certificate, a certificate of deposit for a security, a fractional undivided interest in one or more of a mineral right, a put on a security, a call on a security, a straddle on a security, an option on a security, a privilege on a security, a certificate of deposit, a group of securities (including any interest therein or based on the value thereof), an index of securities (including any interest therein or based on the value thereof), a put on a foreign currency, a call on a foreign currency, a straddle on a foreign currency, an option on a foreign currency, a privilege entered into on a national securities exchange relating to a foreign currency, another interest or instrument commonly known as a security, an investment contract involving a blockchain, a security token, a smart contract, a distributed ledger system, a digital interest in a contract that has the potential to generate a distribution, a real estate investment trust (REIT), a limited partnership interest, a special purpose entity, a master limited partnership (MLP), a closed-ended mutual fund, an open-ended ended mutual fund, an American depository receipt (ADR), an asset backed-security, a mortgage-backed security, a collateralized mortgage obligation, an exchange-traded fund, a money market instrument, a municipal bond, a municipal variable-rate demand obligation, a private placement, a sovereign debt, a unit investment trust, a certificate of one or more of interest in an investment company and participation in an investment company, an investment fund; a pooled investment vehicle, an exchange-traded fund, a mutual fund, and another security. For example, the mineral right comprises a right to one or more of gas, oil, and another mineral.

A security further comprises one or more of a temporary certificate for, an interim certificate for, a receipt for, a guarantee of, a warrant to subscribe to, and a right to do one or more of subscribe to and purchase a security. Embodiments of the invention can be applied to any income-producing security.

A financial distribution (“distribution”) can be defined as one or more of a cash dividend, an interest payment, a principal, a short-term capital gain, a long-term capital gain, a sale of a right relating to an American Depository Receipt (ADR) security, a return of capital, a dividend with an option, a stock split, a stock, an automatic dividend reinvestment, a spinoff, a distribution of rights, an in-kind payment, a liquidation, a tax event, and another financial distribution. The stock dividend comprises one or more of an ordinary stock dividend, a preferred stock dividend, a special stock dividend, and a common stock dividend. For example, the dividend comprises one or more of a dividend in a privately traded stock and another stock dividend. The dividend reinvestment comprises one of more of an ordinary dividend reinvestment, and an increase of shares of stock. The cash dividend comprises one or more of an ordinary cash dividend, relief from payment of a foreign tax, a reclamation of tax, a special dividend, a voluntary dividend reinvestment and another cash dividend. For example, the voluntary dividend reinvestment comprises an increase in a number of shares owned of a security that generated the dividend.

For purposes of this application, a “total distribution” is a distribution paid by a security to investors in a security during a payment period. The payment period is the time period over which a distribution amount is calculated for payment to an investor. For example, a total distribution is a distribution paid by a security to all investors in the security during the payment period. For purposes of this application, an “individual distribution” is a distribution paid by the security to an investor in the security during the payment period. For example, the payment period comprises one or more of a month, a quarter, a half-year, a year, and another payment period.

For purposes of this application, a share comprises an ownership unit of a security. For example, a share comprises one or more of a share of a stock, a number of bonds owned, and another ownership unit of another security.

For purposes of this application, a payment agent comprises an entity configured to do one or more of receive the distribution from the security issuer, compute an equitable allocation of the distribution to at least one investor who owns the security at an end of at least part of a payment period, and pay the equitably allocated distribution to the investor.

Preferably, but not necessarily, the payment agent comprises an entity configured to receive the distribution from the security issuer, further configured to receive data regarding a position of the investor in the security at an end of an interval and data regarding the length of the interval, further configured to compute an equitable allocation of the distribution to at least one investor who owns the security at the end of at least part of a payment period, and further configured to pay the equitably allocated distribution to the investor.

For example, the interval comprises one or more of an hour, a day, two days, three days, and seven days. For example, the interval comprises one weekday. For example, the interval comprises a two-day weekend. For example, the interval comprises a three-day weekend.

Equitable Distribution Method

Embodiments of the invention comprise a method for equitably allocating a financial distribution to a holder of a security. For example, the method accounts for one or more of an interval for which the security is owned and a potentially varying quantity of securities held over one or more intervals in the payment period.

According to certain embodiments of the invention, the number of shares may not be constant throughout an interval, in which case the system and method can use a number of shares owned at an end of the time interval as the shares owned.

The system and method can also be used to allocate a liability of the security. The method can also be used to allocate one or more of a short-term capital gain incurred by the security, a long-term capital gain incurred by the security, a short-term capital loss incurred by the security, and a long-term capital loss incurred by the security. The system operates analogously to embodiments that equitably allocate distributions.

As one example, as part of computing the equitable allocation, the system adds up share-intervals, which are defined as products of a number of shares held at the end of an interval in the payment period times a length of the interval:

share-interval=[(number of shares held at the end of the interval)*(length of interval for which the shares are held)]

For purposes of this application, an individual distribution is defined as equitable when the distribution is equal to the sum of share-intervals in the security during the payment period divided by the sum of all investors' share-intervals in the security during the payment period, and multiplied by the total distribution.

For example, the equitable allocation payable to the investor equals the sum over a payment period of share-intervals for the investor, divided by a sum of share-intervals for all investors during the payment period, multiplied by a total distribution for the security during the payment period.

The system calculates the individual distribution payable to the investor as equal to the sum over a payment period of share-intervals for the investor, divided by a sum of share-intervals for all investors, during the payment period, and then multiplied by the total distribution.

The result of this calculation represents an individual distribution the system computes that the investor in the security receives according to the method for equitably allocating a financial distribution. Commonly, but not necessarily, the result is computed in a currency representing one or more of the investor's currency and a currency used by the security. For example, the currency comprises US dollars. If an investor chooses to receive shares instead of cash, the cash can be converted into shares by dividing the individual distribution by the share price.

One way to look at this example is that for the payment period, the system essentially computes a “time-weighted total” of the number of shares held by a given investor, divided by a “time-weighted total” of the number of shares held by all investors, and multiplied by the total distribution payable during that payment period.

Following is a specific example using an interval of one day and a payment period of 90 days. Investor 1 starts with an investment of 18,000 shares, investor 2 starts with an investment of 0 shares, and investor 3 starts with an investment of 0 shares. A quantity of shares held by an investor can change over the payment period; the equitable distribution method is configured to account for varying quantities of shares held over the payment period. The total distribution payment D in the payment period is $18,000, to be equitably divided up by the system among the three investors according to their respective levels of investment.

Given a total distribution payment D for a payment period, the system computes an equitable distribution payment DP₁₋ᵢₙᵥₑₙₜᵢₒₙ to the first investor, DP₂₋ᵢₙᵥₑₙₜᵢₒₙ to the second investor and DP₃₋ᵢₙᵥₑₙₜᵢₒₙ to the third investor, in this simplified example involving three total investors. First the system computes a total number of share-intervals S₁, S₂, and S₃ for each of the three investors.

So for example, for the first inventor, a formula usable according to embodiments of the invention to compute a total number of (share-intervals) S₁=[(number of shares held by first inventor)*(length of interval for which the first inventor holds the shares)] for a first investor holding x₁ shares of a security on a 1^{st} day of a payment period, holding x₂ shares of a security on a 2nd day of the payment period, holding x₃ shares of the security on a 3^{rd} day of the payment period, and so on, through an nth day of the payment period, is:

(1) S₁=Σᵢ₌₁ⁿxᵢ=x₁+x₂+x₃+ . . . +xₙ, where x₁ equals a number of share-intervals of the security held by the first inventor on the first day, x₂ equals a number of share-intervals of the security held by the first inventor on the second day, and generally xₙ equals a number of share-intervals of the security held by the first inventor on the nth day. The nth day is a last day of the payment period for which the first investor held shares of the security. The nth day may or may not be the final day of the payment period. The system uses parallel formulas to compute a total number of share-intervals S₂ for the second investor and a total number of share-intervals S₃ for a third investor.

In this simplified example, all intervals are equal to one day, so all the multiplications of the number of shares held on each day are multiplied by one.

The system then computes a total number of share-intervals Sₜₒₜₐₗ to be equal to the sum of S₁, S₂, and S₃:

Sₜₒₜₐₗ=S₁+S₂+S₃. (2)

Then the system computes the first equitable distribution payment DP₁₋ᵢₙᵥₑₙₜᵢₒₙ to the first investor by calculating a ratio of share-intervals S₁ for the first investor divided by a total number of share-intervals Sₜₒₜₐₗ for all three investors, the system then multiplying the product by a total distribution amount D for the security during the payment period. That is:

$${DP}_{1 \text{-} invention} = \frac{{S}_{1}}{{S}_{total}} * D = ( \frac{{S}_{1}}{{S}_{1} + {S}_{2} + {S}_{3}} ) * D , \qquad ( 3 )$$

where D is, as mentioned above, the total distribution amount over the payment period. The system uses parallel formulas to compute a second equitable distribution payment DP2 to the second investor and a third equitable distribution payment DP3 to the third investor.

| | | Time | | S1 | | Time | | S2 | | Time | | S3 |
|---|---|---|---|---|---|---|---|---|---|---|---|---|
| Time | Investor | Interval | Product | Running | Investor | Interval | Product | Running | Investor | Interval | Product | Running |
| Interval | S1 | Length S1 | S1 | Sum | S2 | Length S2 | S2 | Sum | S3 | Length S3 | S3 | Sum |
| 1 | 18,000 | 1 | 18,000 | 18,000 | | | | | | | | |
| 2 | 18,000 | 1 | 18,000 | 36,000 | | | | | | | | |
| 3 | 18,000 | 1 | 18,000 | 54,000 | | | | | | | | |
| 4 | 18,000 | 1 | 18,000 | 72,000 | | | | | | | | |
| 5 | 18,000 | 1 | 18,000 | 90,000 | | | | | | | | |
| 6 | 18,000 | 1 | 18,000 | 108,000 | | | | | | | | |
| 7 | 18,000 | 1 | 18,000 | 126,000 | | | | | | | | |
| 8 | 18,000 | 1 | 18,000 | 144,000 | | | | | | | | |
| 9 | 18,000 | 1 | 18,000 | 162,000 | | | | | | | | |
| 10 | 18,000 | 1 | 18,000 | 180,000 | | | | | | | | |
| 11 | 18,000 | 1 | 18,000 | 198,000 | | | | | | | | |
| 12 | 18,000 | 1 | 18,000 | 216,000 | | | | | | | | |
| 13 | 18,000 | 1 | 18,000 | 234,000 | | | | | | | | |
| 14 | 18,000 | 1 | 18,000 | 252,000 | | | | | | | | |
| 15 | 18,000 | 1 | 18,000 | 270,000 | | | | | | | | |
| 16 | 18,000 | 1 | 18,000 | 288,000 | | | | | | | | |
| 17 | 18,000 | 1 | 18,000 | 306,000 | | | | | | | | |
| 18 | 18,000 | 1 | 18,000 | 324,000 | | | | | | | | |
| 19 | 18,000 | 1 | 18,000 | 342,000 | | | | | | | | |
| 20 | 18,000 | 1 | 18,000 | 360,000 | | | | | | | | |
| 21 | 18,000 | 1 | 18,000 | 378,000 | | | | | | | | |
| 22 | 18,000 | 1 | 18,000 | 396,000 | | | | | | | | |
| 23 | 18,000 | 1 | 18,000 | 414,000 | | | | | | | | |
| 24 | 18,000 | 1 | 18,000 | 432,000 | | | | | | | | |
| 25 | 18,000 | 1 | 18,000 | 450,000 | | | | | | | | |
| 26 | 18,000 | 1 | 18,000 | 468,000 | | | | | | | | |
| 27 | 18,000 | 1 | 18,000 | 486,000 | | | | | | | | |
| 28 | 18,000 | 1 | 18,000 | 504,000 | | | | | | | | |
| 29 | 18,000 | 1 | 18,000 | 522,000 | | | | | | | | |
| 30 | 18,000 | 1 | 18,000 | 540,000 | | | | | | | | |
| 31 | 18,000 | 1 | 18,000 | 558,000 | | | | | | | | |
| 32 | 18,000 | 1 | 18,000 | 576,000 | | | | | | | | |
| 33 | 18,000 | 1 | 18,000 | 594,000 | | | | | | | | |
| 34 | 18,000 | 1 | 18,000 | 612,000 | | | | | | | | |
| 35 | 18,000 | 1 | 18,000 | 630,000 | | | | | | | | |
| 36 | 18,000 | 1 | 18,000 | 648,000 | | | | | | | | |
| 37 | 18,000 | 1 | 18,000 | 666,000 | | | | | | | | |
| 38 | 18,000 | 1 | 18,000 | 684,000 | | | | | | | | |
| 39 | 18,000 | 1 | 18,000 | 702,000 | | | | | | | | |
| 40 | 18,000 | 1 | 18,000 | 720,000 | | | | | | | | |
| 41 | 18,000 | 1 | 18,000 | 738,000 | | | | | | | | |
| 42 | 18,000 | 1 | 18,000 | 756,000 | | | | | | | | |
| 43 | 18,000 | 1 | 18,000 | 774,000 | | | | | | | | |
| 44 | 18,000 | 1 | 18,000 | 792,000 | | | | | | | | |
| 45 | 18,000 | 1 | 18,000 | 810,000 | | | | | | | | |
| 46 | 18,000 | 1 | 18,000 | 828,000 | | | | | | | | |
| 47 | 18,000 | 1 | 18,000 | 846,000 | | | | | | | | |
| 48 | 18,000 | 1 | 18,000 | 864,000 | | | | | | | | |
| 49 | 18,000 | 1 | 18,000 | 882,000 | | | | | | | | |
| 50 | 18,000 | 1 | 18,000 | 900,000 | | | | | | | | |
| 51 | 18,000 | 1 | 18,000 | 918,000 | | | | | | | | |
| 52 | 18,000 | 1 | 18,000 | 936,000 | | | | | | | | |
| 53 | 18,000 | 1 | 18,000 | 954,000 | | | | | | | | |
| 54 | 18,000 | 1 | 18,000 | 972,000 | | | | | | | | |
| 55 | 18,000 | 1 | 18,000 | 990,000 | | | | | | | | |
| 56 | 18,000 | 1 | 18,000 | 1,008,000 | | | | | | | | |
| 57 | 18,000 | 1 | 18,000 | 1,026,000 | | | | | | | | |
| 58 | 18,000 | 1 | 18,000 | ,044,000 | | | | | | | | |
| 59 | 18,000 | 1 | 18,000 | 1,062,000 | | | | | | | | |
| 60 | 18,000 | 1 | 18,000 | 1,080,000 | | | | | | | | |
| 61 | | | | 1,080,000 | 18,000 | 1 | 18,000 | 18,000 | | | | |
| 62 | | | | 1,080,000 | 18,000 | 1 | 18,000 | 36,000 | | | | |
| 63 | | | | 1,080,000 | 18,000 | 1 | 18,000 | 54,000 | | | | |
| 64 | | | | 1,080,000 | 18,000 | 1 | 18,000 | 72,000 | | | | |
| 65 | | | | 1,080,000 | 18,000 | 1 | 18,000 | 90,000 | | | | |
| 66 | | | | 1,080,000 | 18,000 | 1 | 18,000 | 108,000 | | | | |
| 67 | | | | 1,080,000 | 18,000 | 1 | 18,000 | 126,000 | | | | |
| 68 | | | | 1,080,000 | 18,000 | 1 | 18,000 | 144,000 | | | | |
| 69 | | | | 1,080,000 | 18,000 | 1 | 18,000 | 162,000 | | | | |
| 70 | | | | 1,080,000 | 18,000 | 1 | 18,000 | 180,000 | | | | |
| 71 | | | | 1,080,000 | 18,000 | 1 | 18,000 | 198,000 | | | | |
| 72 | | | | 1,080,000 | 18,000 | 1 | 18,000 | 216,000 | | | | |
| 73 | | | | 1,080,000 | 18,000 | 1 | 18,000 | 234,000 | | | | |
| 74 | | | | 1,080,000 | 18,000 | 1 | 18,000 | 252,000 | | | | |
| 75 | | | | 1,080,000 | 18,000 | 1 | 18,000 | 270,000 | | | | |
| 76 | | | | 1,080,000 | 18,000 | 1 | 18,000 | 288,000 | | | | |
| 77 | | | | 1,080,000 | 18,000 | 1 | 18,000 | 306,000 | | | | |
| 78 | | | | 1,080,000 | 18,000 | 1 | 18,000 | 324,000 | | | | |
| 79 | | | | 1,080,000 | 18,000 | 1 | 18,000 | 342,000 | | | | |
| 80 | | | | 1,080,000 | 18,000 | 1 | 18,000 | 360,000 | | | | |
| 81 | | | | 1,080,000 | 18,000 | 1 | 18,000 | 378,000 | | | | |
| 82 | | | | 1,080,000 | 18,000 | 1 | 18,000 | 396,000 | | | | |
| 83 | | | | 1,080,000 | 18,000 | 1 | 18,000 | 414,000 | | | | |
| 84 | | | | 1,080,000 | 18,000 | 1 | 18,000 | 432,000 | | | | |
| 85 | | | | 1,080,000 | 18,000 | 1 | 18,000 | 450,000 | | | | |
| 86 | | | | 1,080,000 | | 1 | — | 450,000 | 18,000 | 1 | 18,000 | 18,000 |
| 87 | | | | 1,080,000 | | 1 | — | 450,000 | 18,000 | 1 | 18,000 | 36,000 |
| 88 | | | | 1,080,000 | | 1 | — | 450,000 | 18,000 | 1 | 18,000 | 54,000 |
| 89 | | | | 1,080,000 | | 1 | — | 450,000 | 18,000 | 1 | 18,000 | 72,000 |
| 90 | | | | 1,080,000 | | 1 | — | 450,000 | 18,000 | 1 | 18,000 | 90,000 |

| | |
|---|---|
| S1 Total | 1,080,000 |
| S2 Total | 450,000 |
| S3 Total | 90,000 |
| S Total | 1,620,000 |
| Distribution | $18,000,00 |

| | | Percentage | Distribution |
|---|---|---|---|
| DP 1 | 1,080,000 | 66.67% | 12,000 |
| DP 2 | 450,000 | 27.78% | $5,000 |
| DP 3 | 90,000 | 5.56% | $1,000 |
| Totals | 1,620,000 | 100% | 18,000 |

In this example, the security issuer sends to the payment agent a total distribution D for the payment period of $18,000. The system calculates the share-intervals S₁ of the first investor as 1,080,000 as shown in the chart. The system calculates the share-intervals S₂ of the second investor as 450,000 as shown in the chart. The system calculates the share-intervals S₃ of the third investor as 90,000 as shown in the chart. The system further calculates the total share-intervals Sₜₒₜₐₗ=S₁+S₂+S₃=1,080,000+450,000+90,000=1,620,000.

Using equation (3), the system then computes:

$${DP}_{1 \text{-} invention} = \frac{{S}_{1}}{{S}_{total}} * D = ( \frac{{S}_{1}}{{S}_{1} + {S}_{2} + {S}_{3}} ) * D = \frac{\text{1,080,000}}{\text{1,620,000}} * \text{\$18,000} = 66.67 \% * \text{\$18,000} = \text{\$12,000.}$$

$${DP}_{2 \text{-} invention} = \frac{{S}_{2}}{{S}_{total}} * D = ( \frac{{S}_{2}}{{S}_{1} + {S}_{2} + {S}_{3}} ) * D = \frac{\text{450,000}}{\text{1,620,000}} * \text{\$18,000} = 27.78 \% * \text{\$18,000} = \text{\$5,000.}$$

$${DP}_{3 \text{-} invention} = \frac{{S}_{3}}{{S}_{total}} * D = ( \frac{{S}_{3}}{{S}_{1} + {S}_{2} + {S}_{3}} ) * D = \frac{\text{90,000}}{\text{1,620,000}} * \text{\$18,000} = 5.56 \% * \text{\$18,000} = \text{\$1,000.}$$

The system computes that investor 1 has a 66.67% ownership of the total invested amount over the period of the example and is entitled to the first dividend payment DP₁₋ᵢₙᵥₑₙₜᵢₒₙ of $12,000. The system pays investor 1 the equitably allocated first dividend payment DP₁₋ᵢₙᵥₑₙₜᵢₒₙ of $12,000. By sharp contrast, under the prior art system, investor 1 will receive $0. Under the prior art system only the last holder of record receives a distribution. Since investor 1 sold their shares prior to the record date, investor 1 is not entitled to a distribution under the prior art system.

The system computes that investor 2 has a 27.78% ownership of the total invested amount over the period of the example and is entitled to the second dividend payment DP₂₋ᵢₙᵥₑₙₜᵢₒₙ of $5,000. The system pays investor 2 the equitably allocated second dividend payment DP₂₋ᵢₙᵥₑₙₜᵢₒₙ of $5,000. By sharp contrast, under the prior art system, like investor 1, investor 2 will receive $0. Under the prior art system only the last holder of record receives a distribution. Since investor 2 sold their shares prior to the record date, investor 2 is not entitled to a distribution under the prior art system.

The system has computed that investor 3 has a 5.56% ownership of the total invested amount over the period of the example and is entitled to a third dividend payment DP₃₋ᵢₙᵥₑₙₜᵢₒₙ of $1,000. The system pays investor 3 the equitably allocated third dividend payment DP₃₋ᵢₙᵥₑₙₜᵢₒₙ of $1,000. By sharp contrast, under the prior art system, investor 3 whose ownership represented only 5.56% for the payment period, receives the entire distribution of $18,000. Under the prior art system, the security will drop by the amount of the distribution on the ex-dividend day. Therefore, while it may at first appear that investor 3 is advantaged over investors 1 and 2, the majority of the earnings of investor 3 earnings will be offset by a drop in the value of the security and taxes owed on the distribution.

These respective distributions are equitable because their percentage of the total distribution exactly matches the investors' respective levels of investment. The embodiments of the invention do not have a subsequent drop in the price of the security like the prior art will experience on the ex-dividend day. Even though the prior art investor receives a larger distribution, this is offset by the drop in value of the underlying security. This loss in capital along with the taxes paid on the distribution creates a lower return than the embodiment of the invention investor.

The Appendix contains pseudocode for the method for equitably allocating a financial distribution.

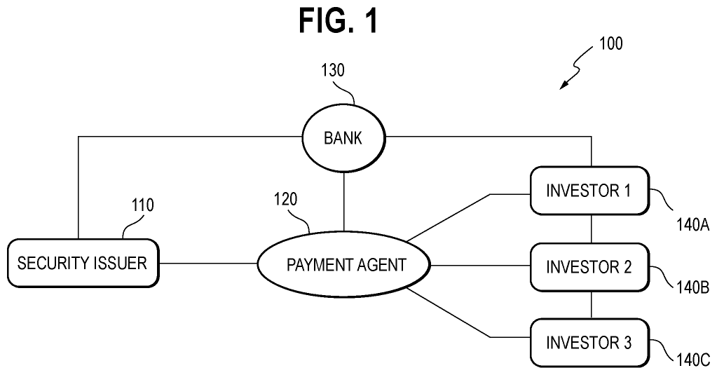

FIG. 1 is a block diagram of a system 100 for equitably allocating a financial distribution. The system 100 comprises a security issuer 110, a payment agent 120 operably connected to the security issuer 110, a bank 130 operably connected to the payment agent 120, and investors 140A, 140B, 140C operably connected to the payment agent 120, the investors 140A, 140B, 140C also each operably connected to the bank 130.

For example, the security issuer 110 comprises one or more of an investment fund, an entity that has issued a stock, an entity that has issued a bond, and another security issuer. The payment agent 120 is configured to receive from the security issuer 110 a declaration that a total distribution will be issued by the security issuer. The payment agent 120 is further configured to aggregate security ownership data using records that the payment agent 120 receives from a data source. Typically, although not necessarily, the payment agent 120 aggregates security ownership data received from a plurality of data sources. For example, the data source comprises one or more of the Depository Trust Company (DTC), a transfer agent, a custodian, a broker-dealer, and another data source.

The security issuer 110 is configured to send distributions to the payment agent 120 to ultimately be equitably allocated using the system 100 for equitably allocating financial distributions to the investors 140A, 140B, 140C. The security issuer 110 sends a total distribution for a payment period to the payment agent 120. For example, the security issuer 110 sends total distributions to the payment agent 120 one or more of nightly, weekly, monthly, quarterly, at an end of the payment period, prior to the end of the payment period, and after the end of the payment period.

The payment agent 120 is configured to retain the total distributions received from the security issuer 110. The payment agent 120 is further configured to compute an individual distribution due to an individual investor for the payment period using the system 100 and method for equitably allocating a financial distribution. The payment agent 120 is further configured to instruct the security issuer 110 to send the total distribution to the bank 130. For example, the payment agent 120 is further configured to instruct the security issuer 110 to send the total distribution to the bank 130 for holding until the payment agent 120 calculates the equitable allocation of financial distributions, at which point the payment agent 120 instructs the bank 130 to send the total distribution to the investors 140A, 140B, 140C. Alternatively, or additionally, the payment agent 120 calculates the equitable allocations of financial distributions to the investors 140A, 140B, 140C after the payment agent determines that aggregated data needed to compute the equitable allocation has arrived to the payment agent, thereby concluding a data aggregation period. For example, data aggregation comprises determining if needed data has arrived to the payment agent or, alternatively, if data is missing that the payment agent needs to compute the equitable allocation of the total distribution.

For example, the data aggregation period can be nearly zero, that is, the conclusion of data aggregation can coincide with the computation of the equitable allocation. For example, the data aggregation period can be approximately ninety days. For example, the data aggregation period can be approximately 180 days. For example, the data aggregation period can comprise a time period between approximately zero up to approximately one year.

The payment agent 120 instructs the bank 130 to pay the equitably allocated individual distribution to the investors 140A, 140B, 140C. Alternatively, or additionally, the payment agent 120 instructs the bank 130 to pay the equitably allocated individual distribution to one or more investors 140A, 140B, 140C via one or more intermediaries (not shown). The payment agent 120 subsequently verifies that the payments were made properly by the bank. For example, the payment agent 120 verifies the payments were made by communicating with the bank 130.

Embodiments of the invention can also be used to produce an estimate of a future distribution for an income-producing security based on an interval for which the security is held. This estimated value of future distributions can be included by one or more of brokers, custodians and investment managers on one or more of account statements and reporting software. The estimated value of future distributions is a real time calculation of accrued income computed pursuant to embodiments of the invention and based on an estimated income for the payment period.

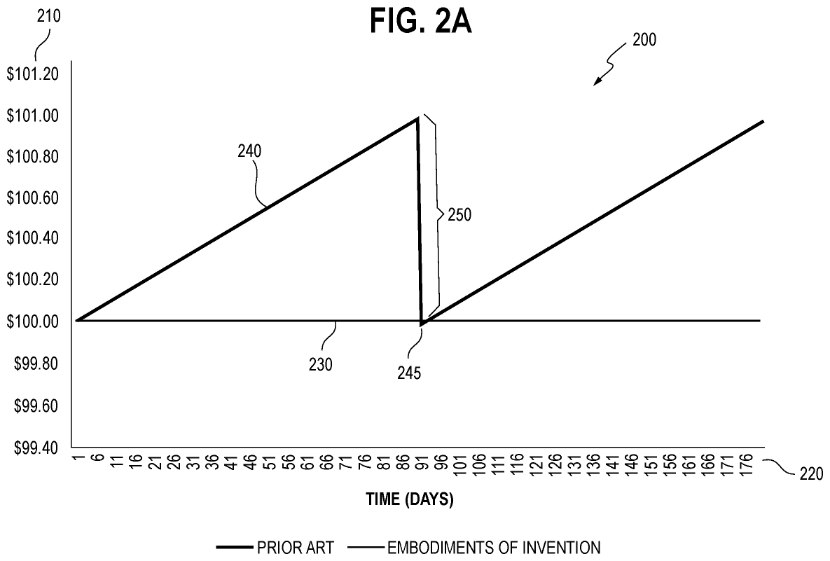

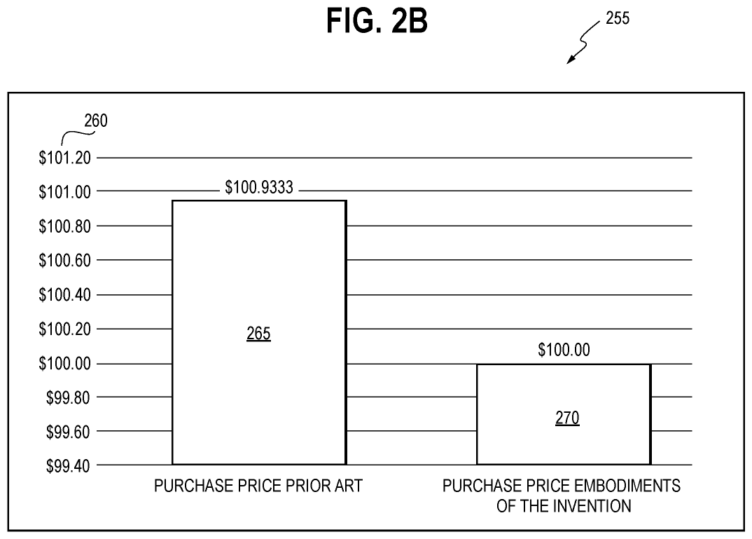

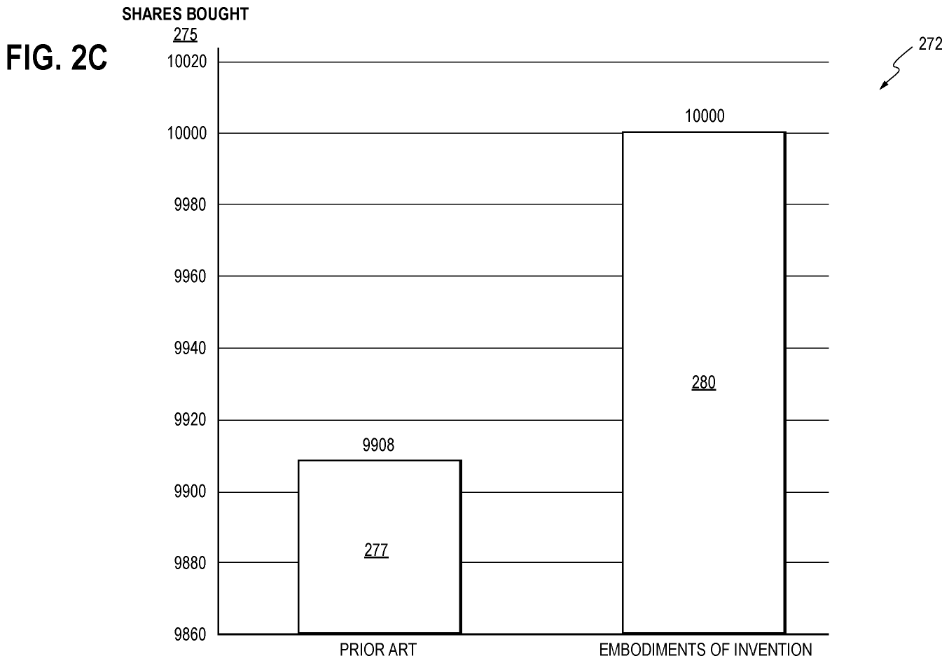

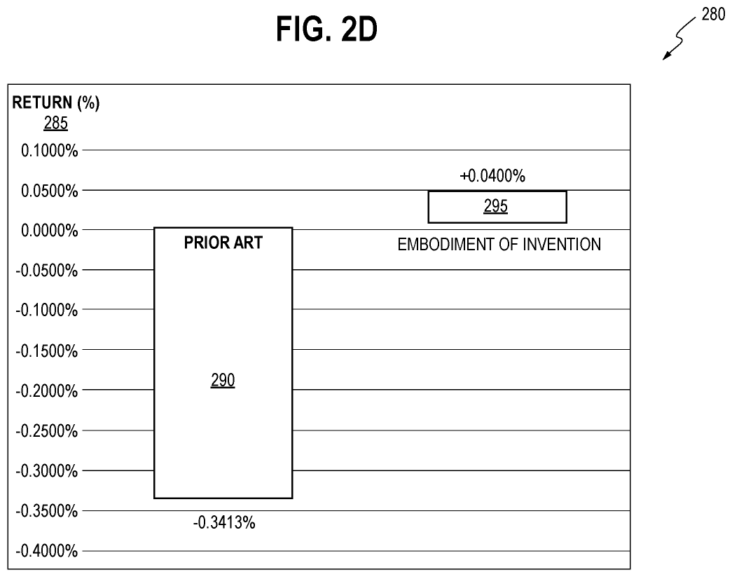

FIGS. 2A-2D depict an example of a method for equitably allocating a financial distribution. This example demonstrates economic advantages of purchasing a security pursuant to embodiments of the invention, relative to a prior art security. The example assumes that there is no market appreciation or depreciation over the ownership period as neither affects the outcome.

In this example, an investor purchases the security on the 85^{th} day of a 90-day quarter. The example shows the net after-tax returns to the investor 1 day after the ex-dividend day or the 91^{st} day, on the “value day”. The table shows number of shares bought, total return on investment, and other relevant transaction data for this example:

Variables

| | |
|---|---|
| Buy Day | 85 |
| Value Day | 91 |
| Buy Amount | $1,000,000 |
| Index Value | 100 |
| Dividend Amount | $1.00 |
| Ordinary Income Tax | 40% |
| Qualified Income Tax | 20% |

| Prior Art | |
|---|---|
| Number of Shares Bought | 9907.52 |
| Appreciation/Capital Gain | $(9,357.11) |
| Dividend Income | $9,907.53 |
| After-Tax Capital Gain | $(9,357.11) |
| After-Tax Dividend Income | $5,944.52 |
| Total Income After-Tax | $(3,412.59) |
| Total Return on Investment | (.3413% ) - Negative Return |

| Embodiments of Invention | |
|---|---|
| Number of Shares Bought | 10,000 |
| Appreciation/Capital Gain | 0 |
| Dividend Income | $666.67 |
| After-Tax Capital Gain | 0 |
| After-Tax Dividend Income | $400.00 |
| Total Income After-Tax | $400 |
| Total Return on Investment | .04% - Positive Return |

FIG. 2A is a chart 200 of price 210 vs. time 220 (days) of a security 230 whose price is computed using the method and system for equitably allocating a financial distribution. FIG. 2A also shows price of a prior art security 240 vs. time 220 (days). The inventive security 230 discounts the distribution gradually over the course of the payment period. The system discounts the price of the security by accruing a liability payable over a course of a payment period to account for an anticipated distribution payment and the drop in the price of the security. Then when the security pays its distribution on an ex-dividend day 245, its price is dropped on the last day of the quarter by a drop amount 250 equal to the distribution, after which the pricing of the prior art security is identical to the pricing of embodiments of the invention on that day.

FIG. 2B is a bar graph 255 of purchase price 260, showing a prior art purchase price bar 265 representing a purchase price of $100.93 under the prior art system and showing an invention purchase price bar 270 representing a purchase price of $100.00 using embodiments of the invention.

FIG. 2C is a bar graph 272 of shares purchased 275, showing a prior art number of shares purchased 277 equal to 9,908 under the prior art system and showing an invention number of shares purchased 280 equal to 10,000 shares purchased using embodiments of the invention.

FIG. 2D is a bar graph 280 of return percentage 285, showing a prior art return percentage 290 under the prior art system of −0.3413% and showing an invention return percentage 295 using embodiments of the invention of +0.0400%.

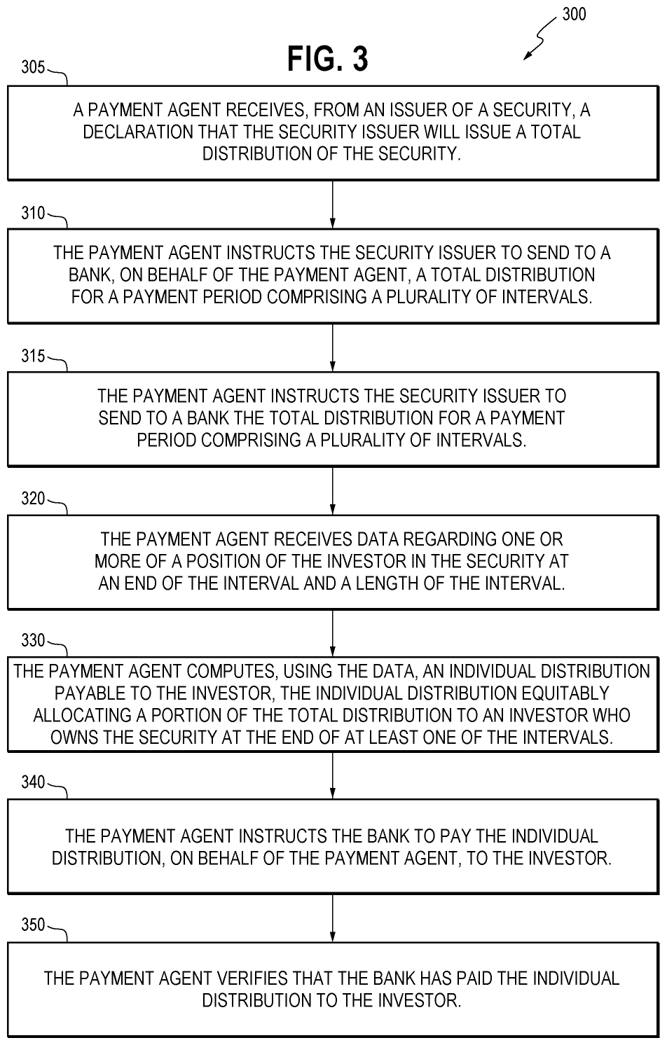

FIG. 3 is a flow chart of a method 300 for equitably allocating a financial distribution.

The order of the steps in the method 300 is not constrained to that shown in FIG. 3 or described in the following discussion. Several of the steps could occur in a different order without affecting the final result.

In step 305, a payment agent receives, from an issuer of a security, a declaration that the security issuer will issue a total distribution of the security. Block 305 then transfers control to block 310.

In step 310, the payment agent instructs the security issuer to send to a bank, on behalf of the payment agent, a total distribution for a payment period comprising a plurality of intervals. For example, the step of instructing further comprises instructing the bank to pay individual distributions to all investors in the security during the payment period. Block 310 then transfers control to block 315.

In step 315, the payment agent instructs the security issuer, to send to a bank the total distribution for a payment period comprising a plurality of intervals. Block 315 then transfers control to block 320.

In step 320, the payment agent receives data regarding one or more of a position of the investor in the security at an end of the interval and a length of the interval. Block 320 then transfers control to block 330.

In step 330, the payment agent computes, using the data, an individual distribution payable to the investor, the individual distribution equitably allocating a portion of the total distribution to an investor who owns the security at an end of at least one of the intervals. For example, computing comprises calculating a sum over the payment period of share-intervals for the investor, where a share-interval comprises a product of a length of the interval at the end of which the investor owned the security and shares of the security owned by the investor at the end of the interval, wherein computing further comprises dividing the sum of share-intervals for the investor by a sum of share-intervals for all investors, during the payment period, and then multiplying by the total distribution. For example, computing comprises calculating the individual distribution payable to the investor as equal to the sum over a payment period of share-intervals for the investor, dividing by a sum of share-intervals for all investors, during the payment period, and then multiplying by the total distribution. Block 330 then transfers control to block 340.

In step 340, the payment agent instructs the bank to pay the individual distribution, on behalf of the payment agent, to the investor. Block 340 then transfers control to block 350.

In step 350, the payment agent verifies that the bank has paid the individual distribution to the investor. For example, the payment agent performs the verification by communicating with the bank. Block 350 then terminates the process.

The method optionally comprises an additional step, performed after the step of receiving the data and before the step of computing, of aggregating, by the payment agent, the data.

The method optionally further comprises an additional step, performed after the step of aggregating the data and before the step of computing, of determining if data is missing that the payment agent needs to compute the equitable allocation of the total distribution.

The method optionally further comprises an additional step, performed after the determining step and before the computing step, of requesting, by the payment agent, that missing data needed to compute the equitable allocation be provided to the payment agent.

The method optionally further comprises an additional step, performed after the requesting step and before the computing step, of determining, by the payment agent, that the aggregated data needed to compute the equitable allocation has arrived to the payment agent, thereby concluding a data aggregation period.

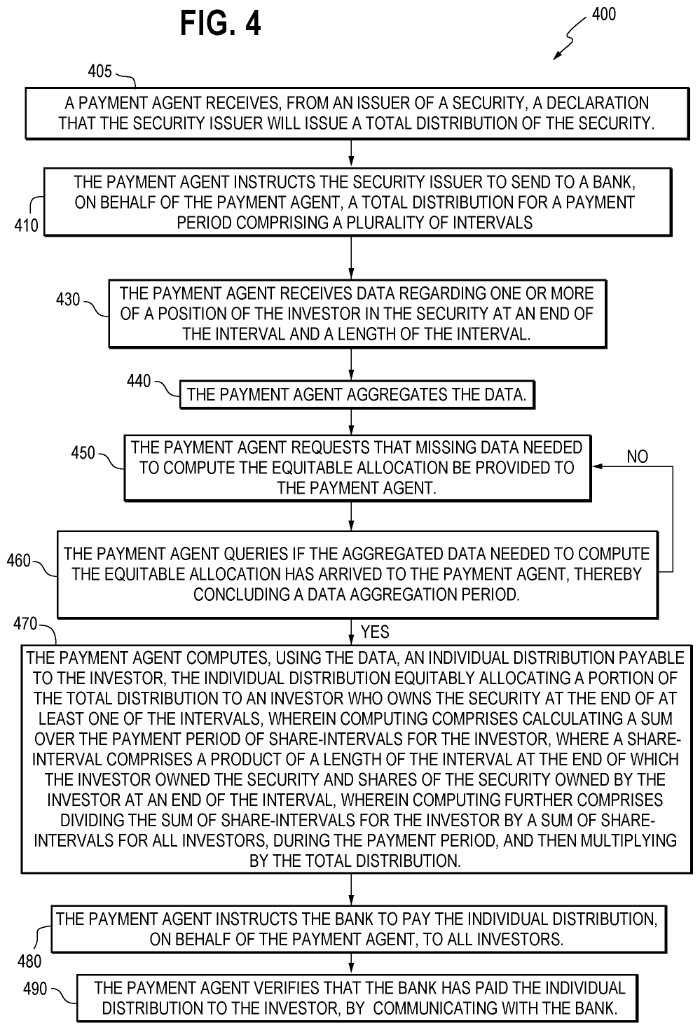

FIG. 4 is a flow chart of a method 400 for equitably allocating a financial distribution.

The order of the steps in the method 400 is not constrained to that shown in FIG. 4 or described in the following discussion. Several of the steps could occur in a different order without affecting the final result.

In step 405, a payment agent receives, from an issuer of a security, a declaration that the security issuer will issue a total distribution of the security. Block 405 then transfers control to block 410.

In step 410, the payment agent instructs the security issuer to send to a bank, on behalf of the payment agent, a total distribution for a payment period comprising a plurality of intervals. Block 410 then transfers control to block 430.

In step 430, the payment agent receives data regarding one or more of a position of the investor in the security at an end of the interval and a length of the interval. Block 430 then transfers control to block 440.

In step 440, the payment agent aggregates the data. Block 440 then transfers control to block 450.

In step 450, the payment agent requests that missing data needed to compute the equitable allocation be provided to the payment agent. Block 450 then transfers control to block 460.

In step 460, the payment agent queries if the aggregated data needed to compute the equitable allocation has arrived to the payment agent, thereby concluding a data aggregation period. If yes, the system proceeds to block 470. If no, the system loops back to step 450.

In step 470, the payment agent computes, using the data, an individual distribution payable to the investor, the individual distribution equitably allocating a portion of the total distribution to an investor who owns the security at the end of at least one of the intervals, wherein computing comprises calculating a sum over the payment period of share-intervals for the investor, where a share-interval comprises a product of a length of the interval at the end of which the investor owned the security and shares of the security owned by the investor at the end of the interval, wherein computing further comprises dividing the sum of share-intervals for the investor by a sum of share-intervals for all investors, during the payment period, and then multiplying by the total distribution. Block 470 then transfers control to block 480.

In step 480, the payment agent instructs the bank to pay the individual distribution, on behalf of the payment agent, to all investors. Block 480 then transfers control to block 490.

In step 490, the payment agent verifies that the bank has paid the individual distribution to the investor, by communicating with the bank. Block 490 then terminates the process.

The term distribution premium is the sum of all, or substantially all, of the distributions that are owed and payable to investors and have been accrued to the value of a security without an offsetting payable liability. Distribution premiums inflate the value of the security above a fair value.

According to embodiments of the invention, the investor who bought an investment fund one day before the ex-dividend date on which a distribution of $1.00 is to be paid would only pay $100 per share (not $101.00 as under the current system) which reflects the exact value of the underlying securities and the investor does not pay a distribution premium because distributions collected over the course of the payment period can be accrued as liabilities. Alternatively, or additionally, according to additional embodiments of the invention, the investor does not pay a distribution premium because distributions collected over the course of the payment period are recorded as an asset with an offsetting liability, which reduces the price by the amount of the distribution payable. Alternatively, or additionally, the investor pays substantially no distribution premium.

An advantage of embodiments of the invention is enabling distribution payments to be accounted for more accurately by accruing distributions owed to investors as payable liabilities. An advantage of embodiments of the invention is elimination of a need to pay the accumulated interest when purchasing a fixed income instrument, thereby promoting one or more of better investment returns and a more efficient market.

An additional advantage of embodiments of the invention is that due to the discounted price of the security, an investor can buy more shares and achieve higher before and after tax investment returns. An additional advantage of embodiments of the invention is that the investor can avoid one or more of volatility and capital losses associated with drops in the individual security prices associated with distributions.

An advantage of embodiments of the invention is that all investors during a payment period who own securities for any length of time receive an individual distribution, unlike the current system in which only the investor holding the security on the last day of the payment period receives the entire distribution and the other investors receive nothing. An advantage of embodiments of the invention is that they allow an investor to avoid paying a distribution premium that is embedded in the price of a single security, thereby achieving one or more of increased buying power, increased before- and after-tax investment returns, and avoidance of adverse tax events. A further advantage of embodiments of the invention is that the currently mandated drop in the securities price on the ex-dividend date will not be necessary since the price of the security will be valued without the distribution premium. An additional advantage of embodiments of the invention is eliminating a potential for investors to game the system by purchasing a security immediately in advance of the ex-dividend date and selling the security on or immediately after the ex-dividend date. A still further advantage of embodiments of the invention is providing prices of securities that are more accurate. A yet other advantage of embodiments of the invention is providing prices of securities that are more beneficial to investors.

Further advantages of embodiments of the invention include ensuring that an investor is paid from the moment the investor buys an income-producing security until the moment the investor sells the income-producing security. A further advantage of embodiments of the invention is enabling an investor holding a fund that comprises another fund to avoid paying multiple distribution premiums at each security level. An additional advantage of embodiments of the invention is thereby preventing an investor from paying substantially more than a value of the underlying investments.

Another advantage of embodiments of the invention is that a frequency of distributions can be changed.

A still further advantage of embodiments of the invention is more equitable allocation of earnings, interest and other distributions. Another advantage is preventing taxation of individuals for transactions to which they were not a principal party. Another advantage of embodiments of the invention is that investors in funds that distribute capital gains will only be responsible for their pro rata share of gains. Another advantage of embodiments of the invention is that the embodiments of the invention are well suited for one or more of an investor planning on holding the security for less than a year, and an investment manager planning on holding the stock for less than a year.

Additional advantages of embodiments of the invention include: 1) Purchasing a security pursuant to embodiments of the invention improves investment return relative to a prior art security. 2) Purchasing a security pursuant to embodiments of the invention also improves an investor's buying power relative to one or more of a prior art security. Therefore, investors can accumulate more shares relative to shares of a prior art security. 3) Purchasing a security pursuant to the embodiments of the invention lowers volatility of the security, which increases its risk-adjusted returns. 4) Purchasing a security according to embodiments of the invention allows an investor to realize more gains as qualified income rather than capital gains, which are taxed up to twice as much. 5) Purchasing an investment fund or single security pursuant to the embodiments of the invention allows the investor to avoid paying the added cost of the embedded distributions or interest when they buy the security as well as avoiding paying increased investment management fees because of the inflated value of the security.

A further advantage of embodiments of the invention is avoiding illogical outcomes in which an investor who owns a fund for 11 months does not incur a taxable event related to the distribution of short- and long-term gains and an investor who buys the fund 15 days before the ex-dividend date is burdened with the entire year's taxable liabilities.

A still further advantage of embodiments of the invention is elimination of current accounting treatment that inflates the value of security beyond its fair value and forces investors to pay a premium for the security. The distribution premium increases investment management fees investors pay to own the security and decreases the number of securities an investor can purchase.

An additional advantage of embodiments of the invention is that an investment fund's tracking error will be reduced.

A yet additional advantage of embodiments of the invention is that they enable investors to make more money. A still additional advantage of embodiments of the invention is they enable a fair pricing of a security.

For example, it will be understood by those skilled in the art that software used by the method and system for equitably allocating a financial distribution may be located in any location in which it may be accessed by the device. It will be further understood by those of skill in the art that the number of variations of the method and device are virtually limitless. It is intended, therefore, that the subject matter in the above description shall be interpreted as illustrative and shall not be interpreted in a limiting sense. For example, interconnections of the different components in the system diagram, FIG. 1, can differ while still operating pursuant to and consistently with the invention.

While the above representative embodiments have been described with certain components in exemplary configurations, it will be understood by one of ordinary skill in the art that other representative embodiments can be implemented using different configurations and/or different components. For example, it will be understood by one of ordinary skill in the art that the order of certain steps and certain components can be altered without substantially impairing the functioning of the invention.

The representative embodiments and disclosed subject matter, which have been described in detail herein, have been presented by way of example and illustration and not by way of limitation. It will be understood by those skilled in the art that various changes may be made in the form and details of the described embodiments resulting in equivalent embodiments that remain within the scope of the invention. It is intended, therefore, that the subject matter in the above description shall be interpreted as illustrative and shall not be interpreted in a limiting sense.

APPENDIX
Following is pseudcode for the method for equitably allocating a financial
distribution:
# Step 1: Define desired distribution
hold_start_date = “01/01/2019”
hold_end_date = “03/01/2019”
distribution_amount = 10000
# Step 2: Add all shares owned by all investors on all days during the

| | |
|---|---|
| # | Ownership Period and interval. |

total_shares = 0
shares_count_list = select shares_owned, interval

```
  from share_ownership_table
  where (ownership_date >= hold_start_date) and
```

(ownership_date <= hold_end_date)

for each share_count in shares_count_list do:

total_shares = total_shares + (share_count * interval)

# Step 3: Get a list of all investors that get the distribution during the
Ownership Period
investor_id_list = select unique owner_id

from share_ownership_table
where (ownership_date >= hold_start_date) and

(ownership_date <= hold_end_date)

# Step 4: Calculate the distribution for each investor
for each inv_id in investor_id_list do:

# Add all shares owned by investor on each day during
# Ownership Period and multiply it by the time interval.
inv_owned_shares = sum (shares_owned * interval)

from share_ownership_table
where (owner_id = inv_id) and

(ownership_date >= hold_start_date) and
(ownership_date <= hold_end_date)

# Calculate the percent of shares owned by the investor
inv_owned_percent = inv_owned_shares/total_shares
# Calculate the investor distribution
inv_distribution_amount = inv_owned_percent *
distribution_amount

What is claimed is:

1. A method for equitably allocating a total distribution of a security to an investor, comprising:
receiving, by a payment agent, from an issuer of a security, a declaration that the total distribution will be issued by the security issuer;
instructing, by the payment agent, to the security issuer, to send to a bank, on behalf of the payment agent, the total distribution for a payment period comprising a plurality of intervals;
receiving, by the payment agent, data regarding one or more of a position of the investor in the security at an end of the interval and a length of the interval;
computing, by the payment agent, using the data, an individual distribution payable to the investor, the individual distribution equitably allocating a portion of the total distribution to an investor who owns the security at the end of at least one of the intervals; and
instructing the bank, by the payment agent, to pay the individual distribution, on behalf of the payment agent, to the investor.

2. The method of claim 1, further comprising a step, performed after the instructing step, of verifying, by the payment agent, that the bank has paid the individual distribution to the investor.

3. The method of claim 2, wherein the verifying step comprises communicating, by the payment agent, with the bank.

4. The method of claim 1, wherein the step of instructing further comprises instructing the bank to pay individual distributions to all investors in the security during the payment period.

5. The method of claim 1, further comprising an additional step, performed after the step of receiving the data and before the step of computing, of aggregating, by the payment agent, the data.

6. The method of claim 5, further comprising an additional step, performed after the step of aggregating the data and before the step of computing, of determining if data is missing that the payment agent needs to compute the equitable allocation of the total distribution.

7. The method of claim 6, further comprising an additional step, performed after the determining step and before the computing step, of requesting, by the payment agent, that missing data needed to compute the equitable allocation be provided to the payment agent.

8. The method of claim 7, further comprising an additional step, performed after the requesting step and before the computing step, of determining, by the payment agent, that the aggregated data needed to compute the equitable allocation has arrived to the payment agent, thereby concluding a data aggregation period.

9. The method of claim 1, wherein computing comprises calculating a sum over the payment period of share-intervals for the investor, where a share-interval comprises a product of a length of the interval at the end of which the investor owned the security and shares of the security owned by the investor at the end of the interval.

10. The method of claim 9, wherein the step of computing comprises calculating the individual distribution payable to the investor as equal to the sum over a payment period of share-intervals for the investor, dividing by a sum of share-intervals for all investors, during the payment period, and then multiplying by the total distribution.

11. A method for equitably allocating a total distribution by a security to an investor comprising:
receiving, by a payment agent, from an issuer of a security, a declaration that the total distribution will be issued by the security issuer;
instructing, by the payment agent, to the security issuer, to send to a bank, on behalf of the payment agent, the total distribution for a payment period comprising a plurality of intervals;
receiving, by the payment agent, data regarding one or more of a position of the investor in the security at an end of the interval and a length of the interval;
aggregating, by the payment agent, the data;
determining, by the payment agent, that data is missing that the payment agent needs to compute the equitable allocation of the total distribution;
requesting, by the payment agent, that missing data needed to compute the equitable allocation be provided to the payment agent;
determining, by the payment agent, that the aggregated data needed to compute the equitable allocation has arrived to the payment agent, thereby concluding a data aggregation period;
computing, by the payment agent, using the data, an individual distribution payable to the investor, the individual distribution equitably allocating a portion of the total distribution to an investor who owns the security at the end of at least one of the intervals, wherein computing comprises calculating a sum over the payment period of share-intervals for the investor, where a share-interval comprises a product of a length of the interval at the end of which the investor owned the security and shares of the security owned by the investor at the end of the interval, wherein computing further comprises dividing the sum of share-intervals for the investor by a sum of share-intervals for all investors, during the payment period, and then multiplying by the total distribution;
instructing the bank, by the payment agent, to pay the total distribution, on behalf of the payment agent, to all the investors; and
verifying, by the payment agent, that the bank has paid the individual distribution to the investor, by communicating, by the payment agent, with the bank.
